(19) United States
(12) Patent Application Publication
(10) Pub. No.: US 2024/0032152 A1
(43) Pub. Date: Jan. 25, 2024

(54) Nanostructured thermomechanical cantilever switch

(71) Applicant: William N. Carr, Raleigh, NC (US)

(72) Inventor: William N. Carr, Raleigh, NC (US)

(21) Appl. No.: 17/871,915

(22) Filed: Jul. 23, 2022

(51) Int. Cl. H05B 1/02; H01H 37/54

(52) U.S. Cl. CPC H05B 1/0213; H01H 37/5418

(57) ABSTRACT

A thermally-sensitive cantilever sensor switch with a bimorph structure based on phononic cantilever structure. Phononic structure increases switch sensitivity to incident absorbed radiation. In embodiments the zero power switch is sensitive to ambient temperature and/or incident absorbed radiation. In embodiments, multiple switches are configured within a spectrometer to provide a means of monitoring toxic components within a media of interest such as smokestake effluents and hot emitters. The switch may be structured with sensitivity to incident radiation within wavelength bands ranging from ultraviolet (UV) to MHz.

### FIELD OF THE INVENTION

The present invention pertains to an apparatus comprising a nanostructured nano- and micro-structured device in the form of a bimorph cantilever actuating a thermal switch.

### BACKGROUND OF THE INVENTION

The field of micromechanics and microengineering better known as MEMS has important applications across a broad range of technologies including semiconductor integrated circuits, with applications focusing into 2- and 3-dimensional structuring. The first semiconductor MEMS device was disclosed by H. Nathanson and R. Wickstrom in U.S. Pat. No. 3,413,573 issued 1968 as a resonant cantilever device disclosing an actuated cantilever modulating the transconductance of a MOSFET transistor.

More recent cantilevered semiconductor MEMS devices include a thermally-actuated single-ended SPST switch with both in-plane (lateral) and out of plane (vertical) actuation disclosed by W. Carr and X-Q Sun in U.S. Pat. No. 5,796,152 issued 1998. Another cantilevered device comprising a thermal MEMS structure with multiple cantilevers providing a capacitive readout is disclosed in G. Fedder and A. Oz, U.S. Pat. No. 7,749,792 issued in 2010.

A MEMS device with bimorph cantilevers is disclosed in M. Rinaldi et al in U.S. Pat. No. 10,643,810 issued in 2020. This MEMS device provides out of plane actuation for a cantilevered SPST switch structure actuated by heat from incident radiation.

The MEMS devices listed above do not comprise a phononic-structured cantilever for enhancement of sensitivity in sensing applications. Prior art cantilevered MEMS switch devices have limitations relating to shock immunity of the cantilever.

It is an object of this invention to provide a more physically robust MEMS switch with structure simplified for semiconductor foundry production tools. It is an object of the present invention to provide a MEMS switch compatible with CMOS on-chip technology. It is an object of the present invention to provide a MEMS switch with increased sensitivity to ambient temperature and/or externally-sourced electromagnetic radiation. It is an object of this invention to provide a MEMS switch sensitive to incident radiation, operational with zero externally-supplied electrical power. It is an object of this invention to provide a MEMS switch within a spectrometer.

### SUMMARY OF THE INVENTION

The salient elements of the invention include:

A thermomechanical cantilever sensor switch (TCSS) wherein a cantilever structure comprises at least one suspended bimorph cantilever actuated in response to internal cantilever temperature, wherein:
one end of each cantilever is anchored on a surrounding substrate;
each cantilever comprises a first and a second thin film leg of different thermal coefficients of expansion, the legs layered together along each cantilever length;
a first metal contact is disposed on the distal end of each cantilever;
switch status is determined by the separation gap between a first metal contact disposed on the end of the first cantilever and a second metal contact, ON status when the contacts touch, and OFF status when the contacts do not touch;
the quiescent status of the switch is normally-ON or normally-OFF determined by the switch structure;
the first cantilever is heated by a sensor absorber sensitive to incident radiation;
at least one thin film leg comprises phononic structure with structural sites separated by distances less than the mean free path (mfp) length for at least some heat conducting phonons, and
the phononic structure decreases the thermal conductivity along a portion of the at least one cantilever leg wherein the ratio of thermal conductivity to electrical conductivity is reduced.

In embodiments the switch is normally OFF. This is accomplished in fabrication by positioning the metal contacts to be normally apart and processing with thermal cycling that maintains the normally OFF switch status. In this disclosure, the drawings depict the switch with cantilevers positioned for normally OFF status.

In other embodiments, the switch is normally ON. This is accomplished in fabrication by using a design mask positioning the metal contacts as close as possible. During fabrication thermal cycling and thermal quenching provides a built-in stress which provides the normally-ON switch status. In this embodiment, relative position of the two legs of each cantilever are reversed compared with normally-OFF to provide an opening of the separation gap with increasing relative temperature of the first cantilever.

In embodiments, a second metal contact is disposed on the surrounding substrate and the sensor absorber is disposed on the first cantilever, providing a switch sensitive to both ambient temperature and absorbed incident radiation. The first metal contact is actuated as ambient temperature changes or as incident radiation is absorbed into the cantilever.

In embodiments the second metal contact is disposed on a second cantilever and the sensor absorber is disposed on the first cantilever, providing a switch sensitive to absorbed incident radiation. The metal contact gap between two cantilevers having identical internal response ambient temperature is invariant with ambient temperature. In this configuration the switch is responsive only to incident radiation absorbed into the sensor absorber of the first cantilever.

In embodiments the sensor absorber is disposed on the first cantilever comprises nanotubes, polycrystalline semiconductor particles, gold black, silicon black, and a plurality of pillars providing increased sensitivity to absorbed radiation within the broadband wavelength range. The sensor absorber may be partially disposed on either or both of the first cantilever legs.

In embodiments, the sensor absorber disposed on the first cantilever comprises one or more of photonic crystal, split ring resonator (SRR), an electromagnetic antenna, LC inductive-capacitive resonator, and metamaterial resonator structures provide sensitivity to absorbed radiation within a limited bandwidth range. In this embodiment the area available for the sensor absorber may be limited by the area included in the first cantilever legs. The area may be increased significantly by extending the area of the first cantilever. The sensor absorber disposed on the first cantilever is sensitive to incident radiation within an ultraviolet UV to millimeter wavelength range.

In embodiments, the sensor absorber is disposed external to a plurality of the first cantilever in series connection, the sensor absorber comprising an antenna sensitive in incident radiation and electrically connected to heat the first cantilever. The antenna is not limited in size by the area of the cantilevers and may be much longer than the cantilever cantilevers. The external antenna provides power to the cantilevers when exposed to incident radiation wherein the cantilevers are resistively heated. The external sensor absorber may be sensitive to narrow or wide bandwidths within the wavelength range UHF to MHz.

Incident radiation into the external antenna may be sourced from an RFID interrogator, and switch enables an RFID transponder. Incident radiation into the external antenna may be supplied from an RFID interrogator and the switch enables an RFID transponder. The wavelength range for the RFID carrier signal into the external antenna ranges from the MHz range up to millimeter wavelengths.

In embodiments the phononic structure is disposed in at least one of the following locations: on a surface of the cantilever, within an interior of the cantilever, on an edge of the cantilever. The phononic structure may comprise poly-crystalline or single-crystalline semiconductor. The phononic structure may be a phononic crystal formed on the bimorph leg of either or both cantilevers wherein heat conducting phonons within a range of ultrasonic frequencies are blocked. In embodiments wherein switch status is insensitive to ambient temperature, each cantilever has identical phononic structure to provide physical symmetry to the switch.

In embodiments the phononic structure comprises one or more of holes, vias, surface pillars, surface dots, plugs, cavities, indentations, surface particulates, roughened edges, implanted molecular species and molecular aggregates disposed in a periodic format, a random format, or both a periodic and a random format.

In embodiments a plurality of the switch adapted into an array format and interconnected to form a network of switches.

In embodiments, network of switches is structured to provide a sensing component within a spectrometer. In embodiments wherein the source of radiation is filtered through a media of interest prior to absorption into the first cantilever, the switch may be configured to detect, without limitation, one or more of O₂, H₂, CO, CO₂, CH₄, H₂S, NO, NO₂, SO₂, and VOC gases. The switch may be a component within a spectrometer wherein the switch status is determined by a component of interest within the media of interest. In embodiments the source of the incident radiation comprises a burning fire, internal combustion engine exhaust. In embodiments the source of radiation may be a laser, LED, LEP or an animal body and the media of interest is air. In embodiments, the source of radiation may be contained within the same enclosure as the spectrometer in the form of a photospectrometer. In embodiments the switch may provide a zero power detector for a remote human.

In embodiments at least a portion of the cantilever structure is hermetically sealed within one or more cavities maintained in a vacuum condition or filled with a gas of low thermal conductance. The hermetic cavity may contain a getter which is heated on demand to increase the vacuum level within the cavity.

The separation between the phononic structure sites ranges upward from about 10 nanometers.

The cantilever lengths may range upward to 10 millimeters, with thickness ranging from nanometers to 100 micrometers.

The separation between metal contacts for the switch in quiescent status ranges from 0 to about 1 millimeter.

### BRIEF DESCRIPTION OF THE DRAWINGS

FIG. 1 depicts three top views of the phononic structure

FIG. 2 depicts planer and cross-sectional views of the first cantilever comprising two legs and a first metal contact.

FIG. 3 depicts a planer view of the first cantilever with the second metal contact disposed on the surrounding substrate wherein movement of the second metal contact changes the gap between metal contacts.

FIG. 4 depicts a planer view of comprising the first and second bimorph elements disposed immediately adjacent to each other on a surrounding substrate.

FIG. 5 depicts a planer view wherein a plurality of the first and second cantilevers are disposed adjacent to each other on a surrounding substrate.

FIG. 6 depicts a planer view wherein the first and second cantilevers are disposed adjacent to each other and the second cantilever is heated by a connected antenna.

FIG. 7 depicts a planer view of the first and second cantilevers configured in circular structures where movement of the metal contacts is within a circular motion.

FIGS. 8A, 8B and 8C depict cross-sectional views of sensor absorber structures.

FIG. 9 depicts a planer view of a sensor absorber structured as a holey photonic crystal.

FIG. 10 depicts planer views of six resonant sensor absorbers.

FIG. 11 depicts planer views of six resonant split ring absorbers

FIG. 12 is a circuit schematic depicting four switches within a series connected array.

FIG. 13 is a cross-sectional view of a single cantilever switch sealed within a hermetic cavity

### DETAIL DESCRIPTION

Definitions as used in this disclosure:

“ambient temperature” means the steady state temperature of the surrounding first platform in thermal equilibrium with the surrounding environment.

“cantilever” means an extended structural member anchored on a surrounding substrate at one end, and with an electrical metal contact disposed on the distal end.

“incident radiation” means an external source of electromagnetic radiation exposed to and absorbed within a first cantilever structure comprising one or more wavelength bands within the range ultraviolet UV to low frequency MHz.

“LED” means a light emitting diode.

“LEP” means a heated micro-platform providing a black body source of radiation.

“phononic crystal” PnC means a periodic arrangement of phonon scattering sites embedded in a semiconductor matrix wherein phonons of certain acoustic frequencies cannot propagate.

“photonic crystal” PhC means a periodic arrangement of sites in a cantilever, generally comprising holes, providing an enhancement of incident photonic radiation over a limited wavelength range.

“quiescent status” means the switch status of normally ON or normally OFF.

“RFID” means a switch sensitive to incident electromagnetic radiation within the millimeter to low MHz frequency range, the switch enabling power to a local transceiver.

“setpoint” means the first cantilever temperature at which the switch status changes from ON to OFF or OFF to ON.

“SPST switch” means an electrical switch providing single pole, single throw electric switching.

“surface plasmonic polariton” SPP means a surface electromagnetic wave guided along a conducting surface having sufficient electrical conductivity to support a plasmonic resonance and absorption of incident radiation within a limited wavelength range.

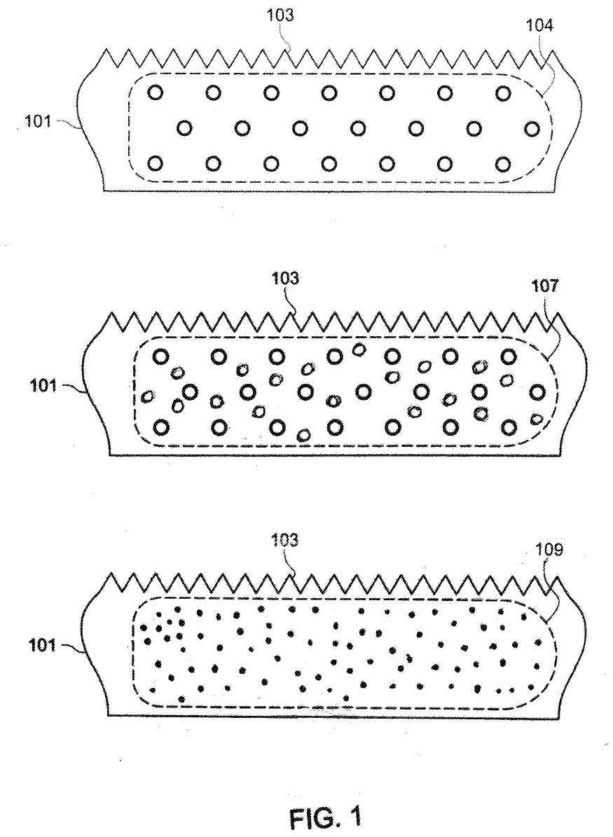

FIG. 1 is an illustrative topside view of phononic structure 101 within a cantilever semiconductor leg. Structure comprising a roughened surface 103 scatters heat conducting phonons thereby reducing thermal conductivity along the length of the leg. The phononic structure may comprise a phononic crystal 104 with sites arranged in an orderly fashion. In a preferred embodiment the phononic crystal comprises “holey” structure having nanoscale separation within one or both cantilever legs. Other phononic scattering structure may be disposed within the bulk of a cantilever leg in the form of randomly disposed scattering sites 107 including holes, indentations, particulates and implanted molecules.

In embodiments, phononic surface scattering over a cantilever area is enhanced by a field of structures 109 with nanoscale separation including vertically-aligned nanotubes and patterned structures. These structures may be patterned with lithography or created randomly. In a preferred embodiment, nanotubes provide areas for the sensor absorber to increase first cantilever sensitivity to incident radiation over a broadband wavelength range.

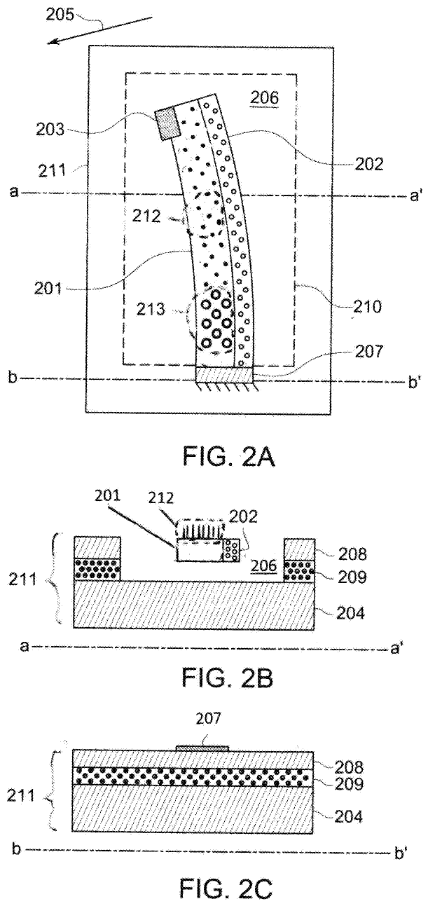

FIG. 2A depicts a plan view and two cross sectional views FIGS. 2B and 2C of an individual first cantilever disposed on a surrounding substrate 211 with anchor 207. The cantilever legs 201,202 and metal contact 203 are suspended over underlying substrate 204 within cavity 206 bounded by perimeter 210. Cross-section a-a′ depicts the cantilever legs 201,202 suspended in cavity 206 bounded by levels 208, 209 of the surrounding substrate 211. In this embodiment, the surrounding substrate 211 formed from an SOI wafer with active layer 208, buried oxide layer 209 and underlying substrate 204. Cross-section b-b′ depicts the anchor 207 disposed over the SOI substrate 211 comprising layers 204, 208, 209.

In the FIG. 2 embodiment the cantilever is formed of legs 201 and 202. Leg 201 comprises phononic structure 213 reducing thermal conductivity and sensor absorptive structure 212. The two legs are bonded together along the cantilever length and form a bimorph cantilever that bends in plane with changes in the cantilever temperature. Leg 202 is formed of a thin film with a higher positive thermal expansion coefficient (TCE) compared with leg 201. The position of contact metal 203 disposed on the distal end of leg 201 is dependent on the temperature of the two legs 201,202 due to the difference in TCE. Contact metal 203 is actuated in direction 205 with increasing temperature of the cantilever within cavity 206.

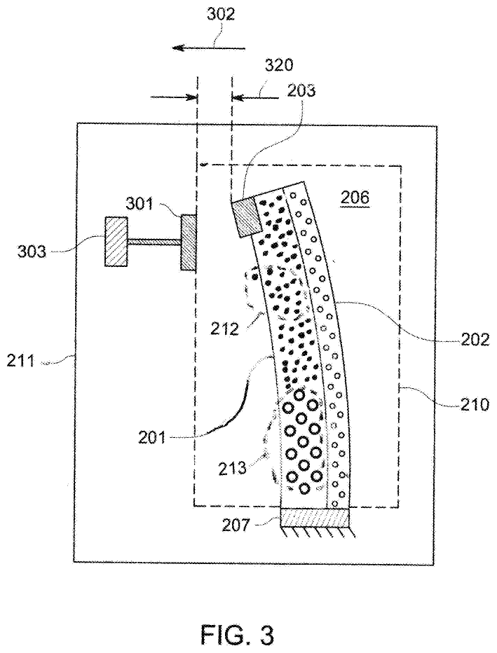

The cantilever of FIG. 3 depicts a plan view of the first cantilever of FIG. 2 within an SPST switch structure wherein the second metal contact 301 with platform connecting pad 303 is disposed on the surrounding substrate 211. In this normally-OFF depiction, the second metal contact is structured to provide electrical connection with the first metal contact 203 when the distal end of the cantilever moves in direction 302. The gap 320 between the two contacts closes with increasing temperature of the cantilever. This switch is a normally OFF switch, closing to ON when temperature reaches a setpoint level.

In another embodiment similar to FIG. 3, a normally-ON switch is obtained by reversing the relative position of the two legs 201, 202 within the cantilever wherein the gap 203 which closes when the first cantilever reaches a setpoint temperature. The embodiment of FIG. 3 provides a switch sensitive to both ambient temperature and sensor absorption into the first cantilever.

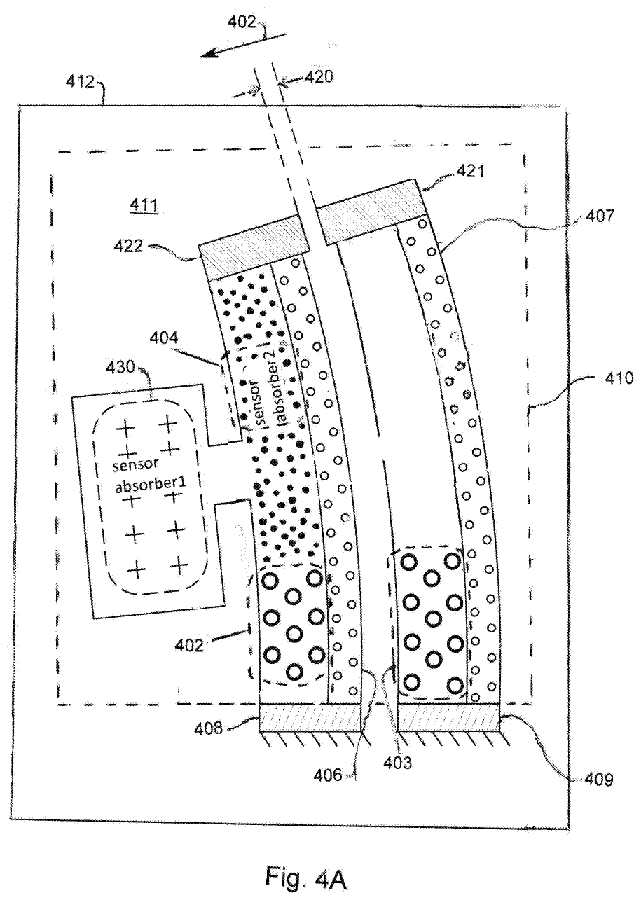

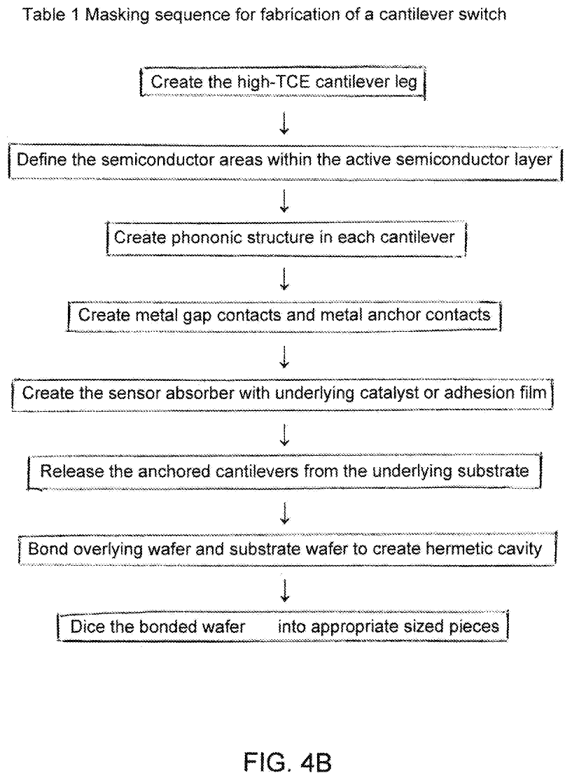

FIG. 4A depicts an embodiment comprising two bimorph cantilevers, a first cantilever and a second cantilever wherein each cantilever rotates in the same vector direction 402 to increase gap 420 with increasing temperature. The gap 420 between metal contacts 421, 421 on the two cantilevers determines the switch status. The sensor absorber 430 is disposed on the first cantilever. In this embodiment wherein the cantilevers are of similar dimension and actuating structure, the gap 420 is independent of ambient temperature in environments wherein there is no incident radiation. The switch is normally-ON, and OFF status is obtained as sensor absorbers 430, 404 heat the first cantilever and gap 420 opens. In this embodiment the switch status is determined by clockwise actuation of metal contact 422 wherein the gap opens with increasing temperature. The two cantilevers are structured with identical internal structure excepting the sensor absorber 430 to provide a switch status independent of ambient temperature in an environment without incident absorbed radiation. With incident absorbed radiation, the first cantilever with sensor absorbers 430 and 404 provide a switch with sensitivity to incident absorbed radiation.

In FIG. 4A the first and second cantilevers suspended from anchors 408, 409 include metal contacts 422, 421, respectively. Semiconductor structure of the first cantilever and second cantilever comprises phononic structure 402, 403 providing thermal isolation to increase thermal sensitivity to heating for each respective cantilever. The first cantilever in embodiments comprises a leg of thin film material 406 having a high positive TCE and low thermal conductivity. The second cantilever in embodiments comprises a leg of thin film material 407 having a low positive TCE.

The switch of FIG. 4A can be reconfigured to provide a normally-OFF status by reversing the relative position of the two cantilevers and the sensor absorber within the cavity.

FIG. 4B discloses a preferred fabrication sequence including the photolithographic masking for the dual cantilever sensor switch of FIG. 4A. Fabrication begins with processing a starting silicon SOI wafer, removing an area within each switch to define a leg area for the dielectric of high TCE and filling this leg with a SiN or MgF2 film. This is accomplished using two lithography masks and RF sputtering of the MgF2. Next the semiconductor area within each leg is defined and phononic structure is created within. Several options are available for the phononic structure wherein one preferred structure is the “holey structure” created with deep submicron lithographic mask or with EBL defined with a software mask.

Metal gap contacts 421, 422 and electrical contacts for the anchor are deposited using lift-off lithography with a sputtered metal such as aluminum or indium. Electrical contacts for the anchors overlays a patterned SiO2 layer as appropriate. Areas around the cantilevers is protected at this processing step by a film which will be resistant to the HF vapor used later to release the cantilevers.

The sensor absorbers 430, 404 are created in separate regions of the first cantilever as appropriate. In a preferred embodiment sensor absorber 430 comprises vertical wall carbon nanotubes formed over a lithographically-defined catalytic ALD film of TiO2 or iron oxide. Sensor absorber 404 may comprise an area patterned with photonic crystal to provide a first cantilever sensitive to two wavelength bands of incident radiation.

Next the cantilevers are released from the substrate retaining the anchors in position tethered to the underlying substrate. This release step is obtained wherein the two cantilever portions are undercut with vapor HF at an elevated temperature. For this release step the two cantilever areas are exposed and the area surrounding each cantilever is protected by a film resistant to the HF etch.

In a preferred embodiment the processed sensor switch is hermetically sealed within a cavity formed by bonding a topside wafer to the sensor switch structure. Wafer bonding can be silicon-to-silicon or adhesive bonded. The hermetic seal is obtained by continuing processing at the wafer level. The resulting sensor switch structure is diced into individual structure as appropriate. In some embodiments, individual dies with the sensor switch also include CMOS readout and control circuitry.

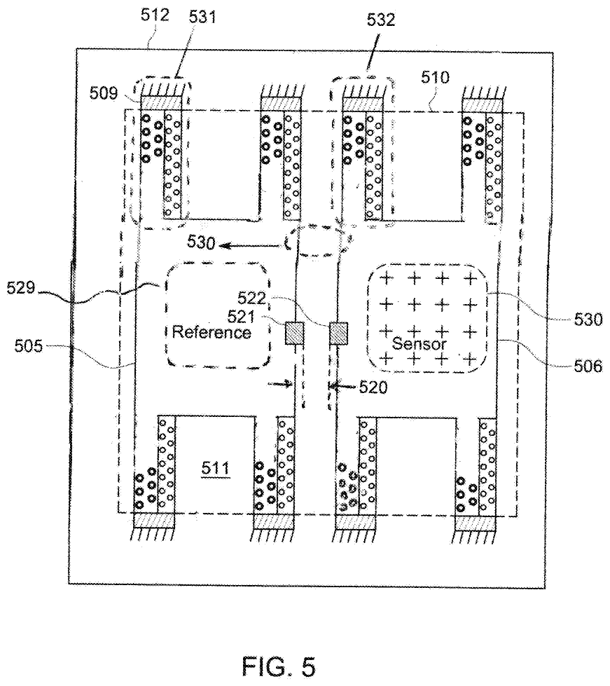

FIG. 5 depicts a switch with a plurality of first cantilever structures 532 comprising sensor absorber platform 530 and reference platform 529 with 4 cantilevers supporting each platform 530. 529 providing a switch with increased shock immunity. The first cantilever structure comprising supporting cantilevers 532 and platform 530 provides an equivalent of the first cantilever with sensitivity to incident radiation. The second cantilever structure comprising supporting cantilevers 531 and platform 529 provides an equivalent of the second cantilever. Reference platform 529 does not comprise a sensor absorber and is provided only for physical symmetry for the two cantilever structures.

The 8 cantilevers of the FIG. 5 switch are suspended with separate anchors 509 disposed on surrounding platform 512 within cavity 511 having periphery 510. The individual cantilevers 531, 532 depicted with anchors 509 have structure similar to the corresponding structures of FIG. 4. Each cantilever is comprised of 2 legs, one leg having a high TCE and the other a lower TCE, thereby providing a means for controlling the gap 520 between the metal contacts 521, 522.

The gap 520 reduces as sensor absorber 530 is heated with incident radiation and the platform 530 moves in vector direction 530 with increasing temperature. The switch status is normally-OFF, changing to ON at a certain higher temperature setpoint. The thermal structure within each cantilever is similar therein providing identical actuation for each cantilever with respect to ambient temperature. The physical symmetry in structure of the 8 cantilevers and platforms 529, 530 provides a switch status independent of ambient temperature. The platforms of FIG. 5 are suspended from a surrounding substrate 512 from anchors 531, 532 within cavity 511 with cavity perimeter 530.

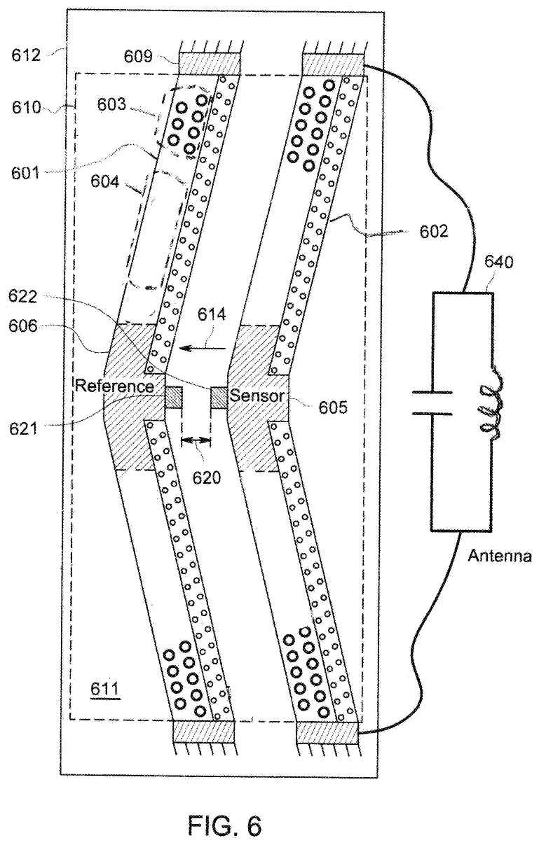

FIG. 6 depicts a normally-OFF sensor switch comprising two sensor absorbers 605, 640 providing a heating of a first dual cantilever. The first and second metal contacts 622, 621 are disposed on the respective distal ends of the first and second cantilever. Each dual cantilever is anchored on surrounding substrate 612 with separate anchors 609. Sensor absorber 605 in embodiments comprises a field of carbon nanotubes as sensitive to incident short wavelengths UV to FarLWIR. Sensor absorber 640 is an antenna sensitive to incident wavelengths millimeter to HF range. The antenna 640 heats the first dual cantilever through a heater current connected through a wired connection 641. With sufficient intensity of incident radiation within appropriate wavelengths, the absorbers heat the first cantilever closing the gap 620 to enable ON status for the switch.

The cantilevers and platforms are disposed within cavity 611 within perimeter 610. The area 604 within the cantilever legs provides an isothermal region adjacent to the high TCE dielectric legs 602. The phononic structured areas 603 provide thermal isolation for the heated areas of each cantilever leg. The high TCE dielectric legs 602 have very low thermal conductivity without the need for phonon structuring. The two metal contacts of gap 620 move in tandem with changing ambient temperature providing insensitivity to ambient temperature. Reference area 606 is a structure insensitive to incident radiation, contributing only to the physical symmetry of the two separate cantilevers.

In other embodiments similar to FIG. 6, an external current source may replace external sensor absorber 640. This current source may be used to reduce the temperature set point for switch status control.

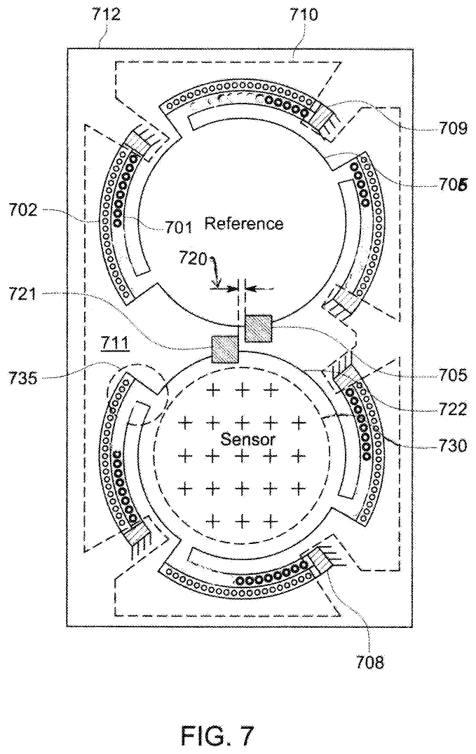

FIG. 7 depicts a normally-OFF switch with a reduced overall footprint area. In this embodiment, a reference platform 706 and a sensor absorber platform 722 provide circular actuation and a normally-OFF status for respective metal contacts 705, 721 with gap 720. The 3 legs of the reference and sensor absorber platforms provide clockwise movement of the metal electrodes as temperature of the platforms increase. The reference and sensor absorber platforms are created with identical structure to provide a switch status independent of ambient temperature. Sensor absorbing structure 730 of first cantilevered structure comprising platform 722 provides heat from incident radiation to enable a switch ON status. Reference platform 706 and sensor absorber platform 722 are suspended by cantilever legs 701,702 from anchors. Sensor platform 705 is suspended by cantilever legs 735 from anchors 708. The two cantilever structures are suspended over a portion of substrate 712.

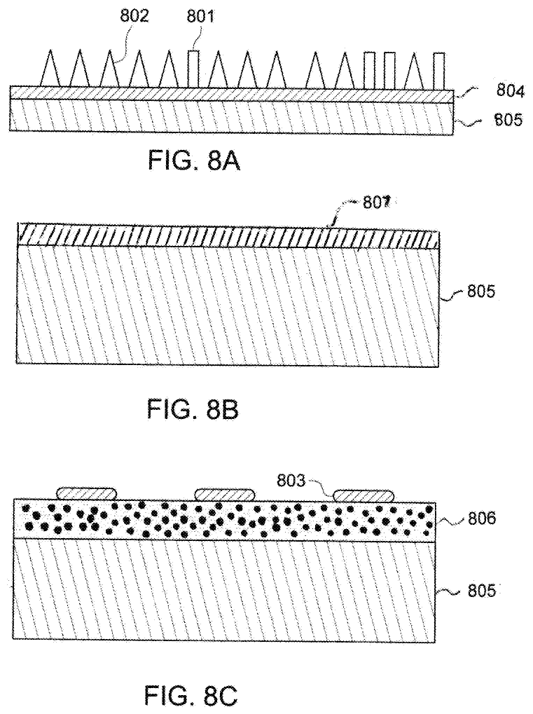

FIGS. 8A, 8B and 8C depict cross-sectional views of a sensor absorber as disposed on a first cantilever. It is structured within a cantilever platform 822 disposed over substrate 805.

FIG. 8A depicts an sensor absorber embodiment comprising a field that includes one or more, without limitation, of nanotubes 801, especially carbon nanotubes, polycrystalline semiconductor particles, and structured pillars 802 of various materials including silicon. FIG. 8B depicts an unstructured surface absorber 807 including gold black, silicon black, other traditional absorbers created as a solution sediment, oxidized films and surface chemical reactants. Some of these absorbers require an underlying ALD catalytic film 804 to promote growth selectively onto sensor absorber platforms of the switch. These absorptive surfaces for the sensor absorber are generally sensitive to a broadband of wavelengths within the UV to millimeter range.

FIG. 8C depicts a cross-sectional view of the sensor absorber structured with metal or dielectric resonators 803 created over dielectric film 806. These resonator structures may include split ring (SRR), LC inductive-capacitive, small electromagnetic antennas and Fabry-Perot types. These sensor absorbers are generally characterized by a Q-factor which supports absorption of incident radiation within a limited wavelength range. Polarized polaritons (SPP) created on the surface of a sensor absorber provide a high Q-factor and deep subwavelength dimensions. Some of these resonators are operational wherein plasmonic-enhancement of surface resonances increases sensitivity of the sensor absorber within a limited wavelength range.

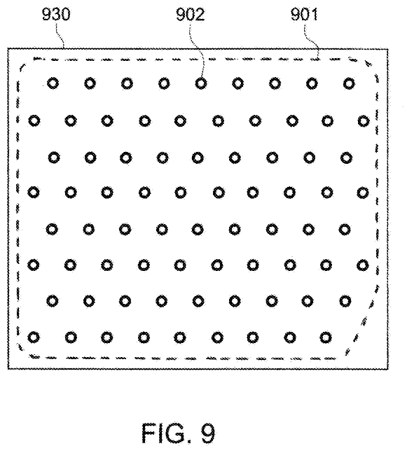

FIG. 9 depicts a sensor absorber 930 with structured with a photonic crystal (PhC) absorber formed within platform 930. A preferred embodiment is the 2-D PhC wherein the structure 901 is an ordered array of holes 902. A common 2-D PhC comprises an orderly-disposed field of holes 902 in a semiconductor supporting substrate.

In certain embodiments of the present invention a photonic structure 901 comprising holes is created in a semiconductor leg. In these structures, the cantilever leg provides both a photonic crystal PhC for absorption of incident radiation over a limited wavelength range, in addition to a phononic crystal PhC for reducing thermal conductivity along the length of said leg.

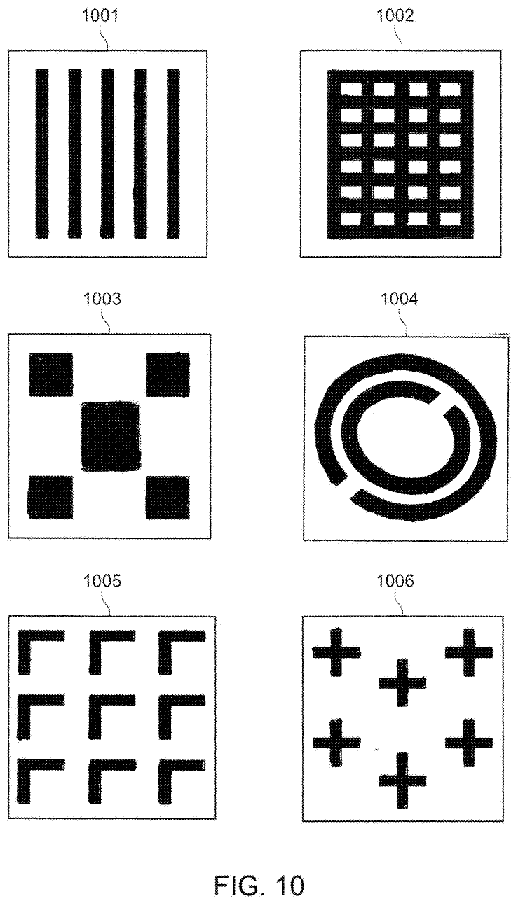

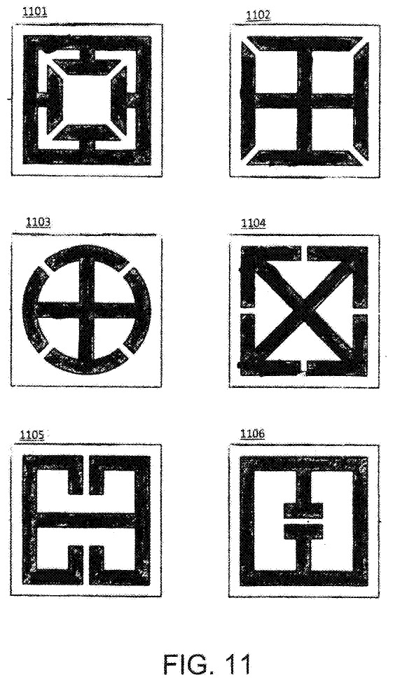

FIGS. 10 and 11 are plan views depicting structured sensor absorbers generally formed of a plurality of metallic resonators disposed either in an ordered or random array. Each of these sensor absorbers may be disposed in array format comprising a plurality of the absorber. These thin film structures provide an increase in the switch spectral response by absorbing incident radiation within the bandwidth of each resonance. Structure 1001 a one-dimensional absorber sensitive to polarization of the incident radiation. Structure 1002 absorbs at a resonance determined by the metallic matrix and dielectric sub pixels within. Structure 1003 absorbs in two separate wavelengths bands corresponding to the two plasmonic resonator dimensions. Structure 1004 is a split ring resonator (SRR). Structures 1005 and 1006 are plasmonic resonators. The resonators of FIG. 10 can be configured into sensor absorber having dimensions ranging from a few microns up to a millimeter. FIG. 11 depicts patterned metal films providing absorptive resonance with multiple bands of wavelength sensitivity.

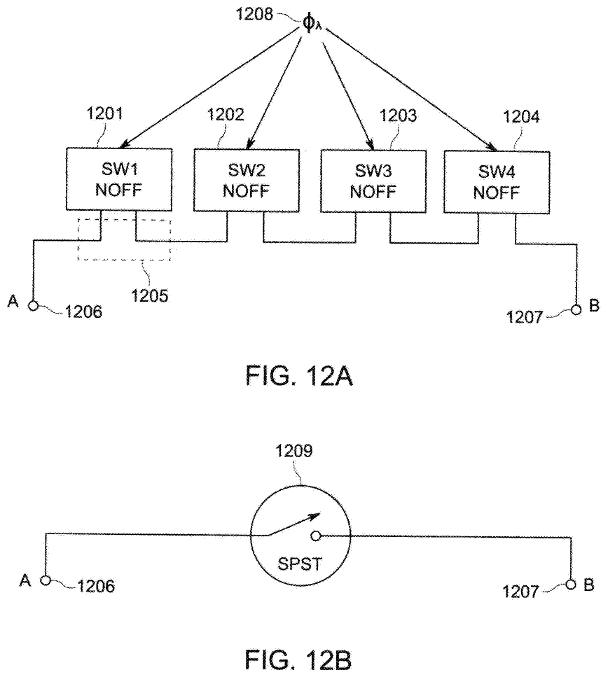

FIGS. 12A and 12B depict a plurality of the switches interconnected to provide a network of switches sensitive to incident radiation 1208. A plurality of the switches may be disposed on a single substrate. Embodiments of the switch can generally be adopted for most substrates including silicon, and especially CMOS silicon systems-on-chip (SoC) applications. In this embodiment four of the switches 1201, 1202, 1203, 1204 are connected in series with external circuit contacts A 1206 and B 1207. These switches are depicted as normally-OFF wherein the switch status changes to ON as incident radiation enables each switch within the array to an ON status. FIG. 12B depicts the equivalent SPST switch 1209 wherein ON status is enabled when each switch within the network has simultaneously absorbed sufficient incident radiation 1208 to enable all sensor switches within the series connection.

In embodiments, the switch may be interconnected within an array comprising both normally-OFF and normally-ON switches to perform a complex function.

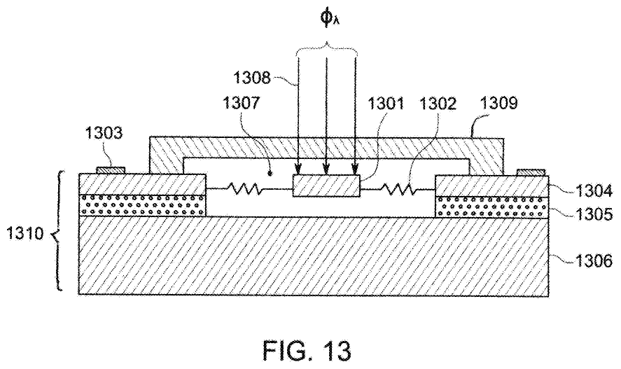

FIG. 13 depicts a cross-sectional view of the switch wherein cantilevers 1302 and platform 1301 are disposed within hermetic cavity 1307. In this illustrative embodiment, the sealed switch is depicted in cross-section as fabricated from a silicon SOI starting wafer. The switch is suspended from surrounding SOI substrate 1310 comprised of active layer 1304 and buried oxide layer 1305. The cavity is sealed within an overlying substrate 1309 bonded to surrounding substrate 1310. In this embodiment, incident radiation 1308 passes through the topside bonded substrate 1309 to heat sensor platform 1301. In embodiments at least a portion of a complex switch comprised of cantilevers and platforms is maintained within a sealed cavity maintained in a vacuum condition or filled with a gas of low thermal conductance. The sealed cavity reduces parasitic unwanted thermal conductivity through air providing an increase in switch sensitivity.

### Example 1—Zero-Power Switch Sensitive to Thermal Ambient and Incident Radiation

In an embodiment based on FIG. 3, structured with sensor absorber 212, the switch is sensitive to both ambient temperature and absorbed incident wherein both legs of the cantilever are heated simultaneously. When not exposed to incident radiation, switch status is dependent only on ambient temperature. The power needed to enable the normally-OFF switch is obtained from heating from ambient environment and absorbed incident radiation.

### Example 2—Zero-Power Switch for Detection of Warm Radiating Objects

The switch cantilever embodiments of FIGS. 4-7 provide sensitivity to warm or hot radiation at extended distances. These embodiments generally require a switch status that is independent of ambient temperature requiring that the thermal structure of the two cantilevers be identical with the exception of a sensor absorber heating the first cantilever. In embodiments structured for normally-OFF status, series-connected switches are interconnected within a network of switches. This structuring can provide a multi-switch array sensitive to more than one wavelength bands. In embodiments the switch is structured to provide a normally-OFF status wherein the switch is enabled to ON if the intensity of incident radiation reaches a predetermined level. Applications may include sensing a burning fire, hot engines and machinery, kitchen oven, and internal combustion engine exhaust, etc. This embodiment can be structured to provide a zero power switch having hyperspectral sensitivity.

This embodiment is useful for detecting a human or animal body at a distance. Two normally-OFF switches are connected in series, one switch sensitive to human body radiation in the 8-12 micrometer wavelength range, and the other sensitive to an overall broadband background radiation in the MWIR-LWIR range. The detection range depends on the designed sensitivity and efficiency of the sensor absorber heating the first cantilever.

### Example 3—Zero-Power Switch within a Spectrometer

The switch embodiments of FIG. 4-7 may be disposed within a spectrometer system wherein a broadband source of radiation that is filtered through a media of interest and a zero-power switch as detector. The system is sensitive to absorption or luminescence within a media of interest which may include a test ampoule disposed in the optical path between the source of radiation and a complex zero-power switch. In embodiments, a range for the density of a toxic gas within the media of interest is detected by multiple switches, each sensitive to a calibrated range of component gases within the media of interest. This embodiment can be structured as a personal, wearable system for monitoring toxic gases in the surrounding atmosphere. The multi-switch detector is sensitive to both the broadband source of radiation and radiation within the wavelengths unique to a component of interest within the media of interest. The filtered beam system may be configured as a spectrophotometer with an internal source of radiation such as one or more of a laser, LED, LEP or incandescent lamp.

In embodiments, the switches of FIG. 3-7 provide micro-dimensioned structure with a silicon chip comprising CMOS and other integrated circuit components. In embodiments, the zero-power switch may be used to enable a battery-powered system for infrequent operation wherein lifetime of the battery in some cases is extended approximately to battery “shelf-life”. The zero-power switch has particular applications within a variety of RFID tag-based systems wherein the tag switch will be used to intermittently enable a connected system for as long as 20 years.

It is to be understood that although the disclosure teaches many examples of embodiments in accordance with the present teachings, additional variations of the invention can easily be devised by those skilled in the art after reading this disclosure. As a consequence, the scope of the presentation is to be determined by the following claims.

What is claimed is:

1. A thermomechanical cantilever sensor switch (TCSS) comprising at least one cantilever with bimorph structure, actuated in response to internal cantilever temperature, wherein:
each cantilever is suspended from a surrounding substrate;
each cantilever provides an electrical connection between an actuated metal contact disposed on the distal end of the at least one cantilever and a stationary electrical contact disposed on the surrounding substrate;
each cantilever comprises first and second isothermal, planar bimorph elements with differing thermal coefficients of expansion, thereby providing a means for actuation of the distal end of the cantilever in the plane of the surrounding substrate in response to internal temperature of the bimorph elements;
each cantilever comprises phononic structure disposed within the length of the cantilever providing enhanced thermal isolation for the isothermal, planar bimorph elements with respect to the surrounding substrate;
the phononic structure comprises structural sites separated by distances less than the mean free path (mfp) length of at least some heat conducting phonons, wherein thermal conductivity within the phononic structure is reduced;
the phononic structure provides an increase in the ratio of electrical conductivity to thermal conductivity within the length of the phononic structure; and
the sensor switch TCSS status is determined by a physical gap between two metal contacts, wherein at least one metal contact is an actuated contact disposed on the distal end of a cantilever, with ON status when the metal contacts touch, and
an OFF status when the two metal contacts do not touch.

2. The TCSS of claim 1 wherein the physical gap is determined by one metal contact disposed at the distal end of a cantilever, and the other metal contact disposed on the surrounding substrate, providing a sensor switch status sensitive to temperature of the surrounding substrate and local environment.

3. The TCSS of claim 1 comprising two cantilevers wherein the physical gap is determined by the separation of the two metal contacts on the distal end of each cantilever, providing a sensor switch status sensitive to the temperature differential between the isothermal, planar bimorph elements of the separate cantilevers, and independent of temperature of the surrounding substrate and local environment.

4. The TCSS of claim 1 comprising a sensor absorber structure sensitive to exposed incident radiation, wherein the incident radiation heats the isothermal, planar bimorph element of at least one cantilever providing a sensor switch sensitive to the incident radiation.

5. The TCSS of claim 4 wherein the incident radiation is sourced from a burning fire, internal combustion engine exhaust, laser, LED, LEP or a nearby warm animal.

6. The TCSS of claim 4 wherein the incident radiation is sourced from an RFID interrogator, detected by an electromagnetic antenna electrically-connected provide I²R heating within a bimorph element.

7. The TCSS of claim 4 wherein the sensor absorber comprises, without limitation, nanotubes, polycrystalline semiconductor particles, gold black, silicon black, and a plurality of pillars providing increased sensitivity to the absorbed incident radiation within a broadband wavelength range.

8. The TCSS of claim 4 wherein the sensor absorber comprises, without limitation, one or more of photonic crystal, split ring resonator (SRR), an electromagnetic antenna, LC inductive-capacitive resonator, and metamaterial structure providing sensitivity to absorbed incident radiation within a limited bandwidth range.

9. The TCSS of claim 4 wherein the sensor absorber comprises a portion of the phononic structure.

10. The TCSS of claim 1 wherein the phononic structure comprises phononic crystal having an orderly structure, wherein transport of heat conducting phonons within a range of ultrasonic frequencies are blocked.

11. The TCSS of claim 1 wherein the phononic structure comprises a plurality of holes, vias, surface pillars, surface dots, plugs, cavities, indentations, surface particulates, roughened edges, implanted molecular species and molecular aggregates disposed in a periodic format, a random format, or both a periodic and a random format.

12. The TCSS of claim 1 wherein the phononic structure comprises a semiconductor material such as silicon.

13. The TCSS of claim 1 wherein the first planar bimorph element comprises a material of lower thermal coefficient of expansion including, without limitation, a semiconductor.

14. The TCSS of claim 1 wherein the second planar bimorph element comprises, without limitation, silicon nitride, magnesium fluoride or a thin metal film having a thermal coefficient of expansion larger than the first planar bimorph elements.

15. The TCSS of claim 1 comprising a plurality of the sensor switch adapted into an array format, wherein the plurality of switches is interconnected to form a network of switches.

16. The TCSS of claim 1 wherein at least a portion of the cantilever structure is hermetically sealed within one or more cavities and maintained in a vacuum condition or filled with a gas of low thermal conductance.

17. The TCSS of claim 1 wherein sensitivity is provided by the sensor absorber structure for one or more bands of incident radiation within the range ultraviolet to high frequency (HF) wavelengths.

18. The TCSS of claim 1 comprising a detector within an optical spectrometer.

19. The TCSS of claim 1 comprising one or more cantilevers of length ranging up to 10 millimeters, and thickness ranging from 10 nanometers to 100 micrometers.

20. A method for fabrication of the TCSS of claim 1 comprises the following steps:
create the high-TCE cantilever leg;
define the semiconductor areas within the active semiconductor layer;
create phononic structure in each cantilever;
create metal gap contacts and meal anchor contacts;
create the sensor absorber with underlying catalyst or adhesion film;
release the anchored cantilever from the underlying substrate;
bond an overlying wafer to the substrate wafer to create the hermetic cavity; and
dice the bonded wafer into appropriate sized pieces.

22. A thermomechanical cantilever sensor switch (TCSS) configured with a first and second actuated electrical contact actuated independently to provide a SPST switch function, wherein the first contact is disposed-on, and electrically-connected with, a first bimorph within a first cantilever, and the second contact is disposed on and electrically-connected with a second bimorph within a second cantilever, wherein both cantilevers are suspended from a surrounding substrate;
The bimorphs each comprise two fused legs, wherein each leg comprises a different thermal coefficient of expansion (TCE);
the first bimorph of the first cantilever is thermally-connected to thermal absorbing structure.
the electrical status ON and OF is defined by the actuated electrical contacts in touching and not touching positions, respectively;
the electrical status ON or OFF is determined by the temperature differential between the two bimorphs;
the first and second cantilevers comprise phononic MEMS structure disposed to provide thermal isolation between the respective bimorphs and the surrounding substrate;
the thermal isolation provided by the phononic MEMS structure increases the thermal sensitivity for actuated movement of each electrical contact;
the phononic MEMS structure comprises phononic crystal with elements disposed in an orderly format, and/or scattering elements disposed in a random format;
the first and second electrical contacts are electrically connected through each respective first and second cantilevers to external contacting pads disposed on the surrounding platform.
the switch status ON or OFF changes as the intensity of incident radiation heating the morph within the first cantilever reaches a specific level.

23. The TCSS of claim 22 wherein the thermal sensitivity of the two actuating cantilevers is identical without external radiation incident to the first cantilever is independent of the surrounding platform temperature.

24. The TCSS of claim 23, wherein the first cantilever comprises thermal absorbing structure and the TCSS electrical status changes when external radiation intensity reaches a specific intensity.

25. the two cantilevers are configured to provide a quiescent electrical status of the TCSS of normally-ON or normally-OFF.

26. The TCSS of claim 22 wherein the phononic structure comprises a field of nanotubes, holes, vias, surface pillars, surface dots, plugs, cavities, indentations, surface particulates, roughened edges, implanted molecular species and molecular aggregates.

27. The thermal absorbing structure is disposed within the bimorph, or thermally-connected to thermal absorbing structure disposed in close proximity to the bimorph, providing a sensitivity to incident radiation absorbed from an external photonic source;

28. The TCSS of claim 22 wherein the thermal absorbing structure comprises nanotubes, polycrystalline semiconductor particles, gold black, silicon black, and a plurality of pillars, thereby providing increased switch thermal sensitivity to incident radiation within a broadband wavelength range.

29. The TCSS of claim 22 wherein thermal absorbing structure comprises one or more of a photonic crystal, split ring resonator (SRR), electromagnetic antenna, LC inductive-capacitive resonator, Fabry-Perot interferometer, and metamaterial resonator structure, providing increased switch thermal sensitivity to incident radiation within a limited wavelength range.

30. The TCSS of claim 27 wherein the thermal absorbing structure comprises an RFID antenna within an RFID system.

31. The TCSS of claim 22 thermally connected to one leg of the first bimorph wherein the thermal absorbing structure is sensitive to absorption within or luminescence from an external media of interest.

32. The TCSS of claim 22 configured as a spectrometer to provide a means of identification for a fire, internal combustion engine exhaust gases, laser, LED, LEP, or blackbody radiation from a live animal.

33. The TCSS of claim 22 configured to provide a means of monitoring separately, without limitation, O₂, H₂, CO, CO₂, CH₄, H₂S, NO, NO₂, SO₂, and VOC environmental gases.

34. The TCSS of claim 22 adapted to comprise a plurality of TCSS switches, providing identification or monitoring of a plurality of incident radiation wavelengths.

35. The TCSS of claim 32, providing an array further comprised of normally-OFF and normally-ON switches interconnected within a matrix.

36. The TCSS of claim 22 wherein the first cantilever is disposed within a hermetic cavity maintained in a vacuum condition or filled with a gas of low thermal conductance.

37. The TCSS of claim 35 wherein the hermetic cavity comprises a getter compound providing an increased cavity vacuum when activated.

38. The TCSS of claim 22 wherein the cantilever structure is based on poly or single crystalline semiconductor, and the preferred semiconductor is silicon.

39. The TCSS of claim 22 wherein the overall length of the cantilevers ranges up to 10 millimeters.

40. The TCSS of claim 22 wherein the cantilever morph thickness ranges from 10 nanometers to 100 micrometers.

41. The TCSS of claim 22 wherein the actuated separation of the electrical switches ranges from 0 to about 1 millimeter.
